(19) United States
(12) Patent Application Publication
(10) Pub. No.: US 2008/0070024 A1
(43) Pub. Date: Mar. 20, 2008

(54) Layered fire retardant barrier panel

(76) Inventors: William F. Curran, Hamburg, NY (US); Hugh J. Rundle, Rochester, NY (US)

Correspondence Address: PHILLIPS LYTLE LLP;INTELLECTUAL PROPERTY GROUP, 3400 HSBC CENTER, BUFFALO, NY, 14203-3509, US

(21) Appl. No.: 11/891,169

(22) Filed: Aug. 9, 2007

Related U.S. Application Data
(60) Provisional application No. 60/836,794, filed on Aug. 10, 2006.

(51) Int. Cl. B32B 17/00; B29C 33/38; B32B 5/00; C09K 21/00

(52) U.S. Cl. 428/293.4; 264/45.2; 428/327

(57) ABSTRACT

A fire retardant barrier panel (16) comprising a first protective layer (18) of a first material and a fire resistant phenolic-based resin layer (19) bonded to the protective layer. The first material may be selected from the group consisting of gypsum, ceramic fiber, phenolic foam, basalt, fiberglass, carbon fiber, mineral wool and intumescent materials. The resin may be a phenol or phenolic resin. The fire retardant barrier panel may further comprise a second protective layer (20) bonded to the resin layer (19) such that the resin layer is between the first and second protective layers. The second protective layer (20) may be selected from the group consisting of gypsum, ceramic fiber, phenolic foam, basalt, fiberglass, carbon fiber, mineral wool and intumescent materials.

### CROSS-REFERENCE TO RELATED APPLICATIONS

This application claims the benefit of U.S. Provisional Patent Application No. 60/836,794, filed Aug. 10, 2006. The entire content of such application is incorporated by reference herein.

### TECHNICAL FIELD

The present invention relates generally to fire retardant materials, and more particularly to a layered phenolic-resin-based fire retardant panel.

### BACKGROUND ART

The use of phenolic resins for fire resistance is known in the prior art. For example, U.S. Pat. No. 5,079,078 discloses a fire resistant panel of woven glass preimpregnated with a phenolic resin. The panel is formed as a single layer by a compression molding technique that utilizes pressure of 50-100 psi at a temperature of 350 degrees for 20-30 minutes. U.S. Pat. No. 5,320,870 discloses a method of spraying phenolic resin compositions to form an outer fire protective coating.

Phenolic-based resin panels are known in the prior art for uses other than fire prevention. U.S. Pat. No. 4,503,115 teaches a decorative molded panel made with thermoplastic resin, such as a phenolic-based resin.

Although phenolic resin is known for its fire-resistant properties, the methods of creating fire retardant panels and enclosures in the prior art are complicated and time consuming. There is a need, therefore, for an improved fire retardant panel with improved thermal properties that can be fabricated cost-efficiently.

### BRIEF SUMMARY OF THE INVENTION

With parenthetical reference to the corresponding parts, portions or surfaces of the disclosed embodiment, merely for purposes of illustration and not by way of limitation, the present invention provides an improved fire retardant barrier panel (16) comprising a first protective layer (18) of a first material and a fire resistant phenolic-based resin layer (19) bonded to said protective layer. The first material may be selected from the group consisting of gypsum, ceramic fiber, phenolic foam, basalt, fiberglass, carbon fiber, mineral wool and intumescent materials. The resin may be a phenol or phenolic resin.

The fire retardant barrier panel may further comprise a second protective layer (20) bonded to the resin layer (19) such that the resin layer is between the first and second protective layers. The second protective layer (20) may be selected from the group consisting of gypsum, ceramic fiber, phenolic foam, basalt, fiberglass, carbon fiber, mineral wool and intumescent materials.

In another aspect, the invention includes a method of creating a fire retardant barrier panel comprising the steps of mixing water, resin, and surfactant with boric acid and expandable filler, adding a catalyst, providing a mold (23), pouring the mixture into the mold (23), and allowing the mixture to harden. The mold (23) may be lined on at least one side with a first protective material. The first protective material may be selected from the group consisting of gypsum, ceramic fiber, phenolic foam, basalt, fiberglass, carbon fiber, mineral wool and intumescent materials. The method may include coating at least one side of the hardened mixture with a first protective layer selected from the group consisting of gypsum, ceramic fiber, phenolic foam, basalt, fiberglass, carbon fiber, mineral wool and intumescent materials. The coating may form a layer (18) that bonds to the hardened mixture (19) without adhesive.

Accordingly, the general object of the invention is to provide an improved fire retardant panel.

Another object is to provide an improved fire retardant panel that withstands high temperatures.

Another object is to provide an improved fire retardant panel for use in a fireproof safe or fireproof cabinet that can protect items inside the safe or cabinet from thermal damage.

Another object is to provide an improved fire retardant panel having a phenol resin layer or a phenol resin inner core.

Another object is to provide an improved fire retardant panel that effectively delays heat transfer from one side to the other.

Another object is to provide an improved fire retardant panel that does not utilize adhesives to bind layers together.

Another object is to provide a simple method for manufacturing an improved fire retardant panel.

These and other objects and advantages will become apparent from the foregoing and ongoing written specification, the accompanying drawings and the appended claims.

### BRIEF DESCRIPTION OF THE DRAWINGS

FIG. 1 is a perspective view of a first embodiment of a fire retardant panel.

FIG. 2 is a sectional view of the embodiment shown in FIG. 1, taken generally on line 2-2 of FIG. 1.

FIG. 3 is a perspective view of a heat source applied to the fire retardant panel shown in FIG. 1.

FIG. 4 is a table of 60-minute test results for the panel shown in FIG. 3.

FIG. 5 is a graph of 60-minute test results for the panel shown in FIG. 3.

FIG. 6 is a perspective view of a second embodiment of a fire retardant panel.

FIG. 7 is a perspective view of the panel shown in FIG. 6 together with a backing plate and a heat source applied to the panel.

FIG. 8 is a table of 60-minute test results for the panel shown in FIG. 7.

FIG. 9 is a graph of the 60-minute test results for the panel shown in FIG. 7.

FIG. 10 is a perspective view of a third embodiment of a fire retardant panel.

FIG. 11 is a sectional view of the embodiment shown in FIG. 10, taken generally on line 11-11 of FIG. 10.

FIGS. 12a-f is a table of ASTM E119 3-hour test results for the panel shown in FIG. 10.

FIG. 13 is a graph of ASTM E119 3-hour test results for the panel shown in FIG. 10.

FIG. 14 is a perspective view of the mold used in the process by which the fire resistant panel shown in FIGS. 1 and 6 is made.

FIG. 15 is a perspective view of the mold used in the process by which the fire resistant panel shown in FIG. 10 is made.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

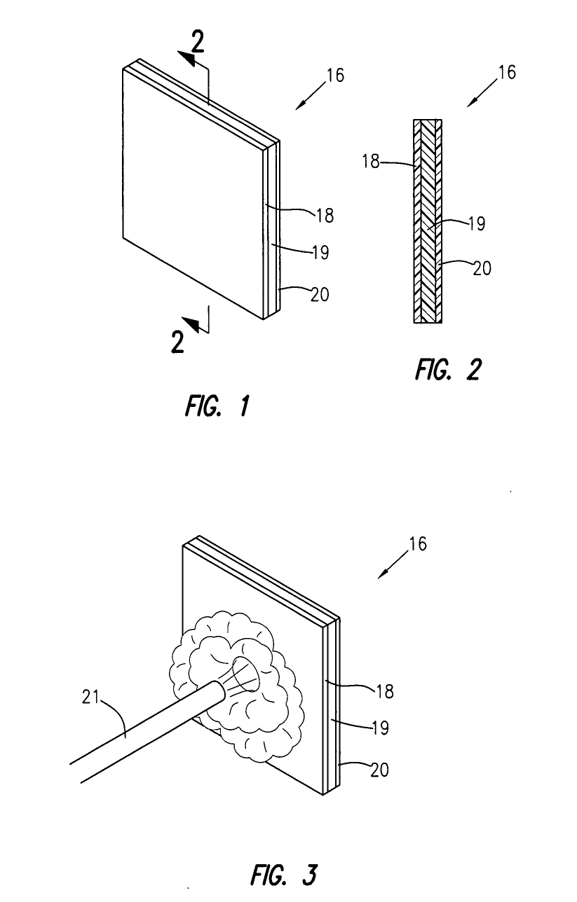

Referring now to the drawings, and, more particularly, to FIG. 1 thereof, the present invention provides a layered composite panel thermal management system, the preferred embodiment of which is generally indicated at 16. As shown in FIG. 1; panel 16 generally comprises a resin layer 19 laminated between two protective layers 18 and 20, respectively.

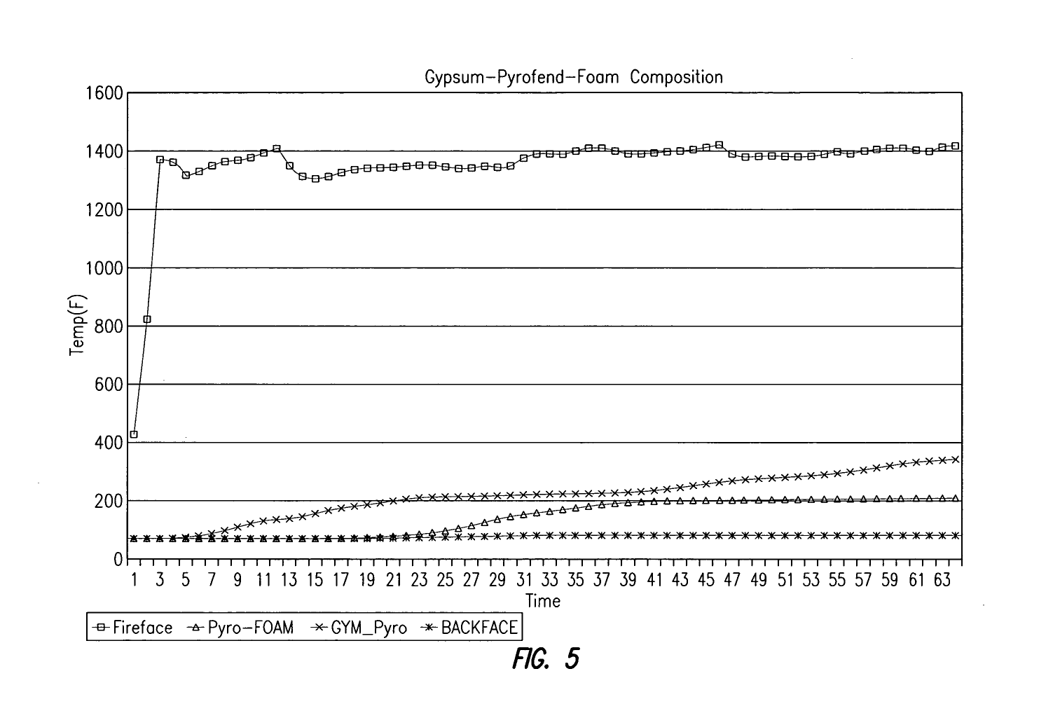

In this first preferred embodiment, fire retardant panel 16 has a total thickness of 2¼ inches. Protective layer 18 is ⅝ inch thick and made of gypsum. It is contemplated, however, that both the material used and thickness of layer 18 may vary depending on the application. For example, protective layer 18 may be formed of other materials such as ceramic fiber, phenolic foam, basalt, fiberglass, carbon fiber, mineral wool or intumescent materials. Although protective layer 18 in this embodiment is a thermal barrier material, alternatively, layer 18 may be a coating. As shown in FIG. 3, protective layer 18 is adapted to be placed between the anticipated heat source 21 and resin layer 19. It has been found that the thermal properties of the core resin layer are improved with the use of this protective outside layer.

Resin layer 19 is a phenolic resin composition. In the preferred embodiment, resin layer 19 is made with water, phenolic resin, surfactant, boric acid, a lightweight expandable filler, and a catalyst. Resin layer 19 is 1⅛ inches thick. The thickness of layer 19, however, may vary depending on the application.

Protective layer 20 is adapted to be the furthest layer from heat source 21. Protective layer 20 therefore serves as the final barrier layer between heat source 21 and the items panel 16 means to protect. The exterior face of protective layer 20, which is on the side opposite heat source 21 is referred to as the cold face of panel 16. The cold face is the outer surface of panel 16 that is the greatest distance from heat source 21, and closest to the protected items. Protective layer 20 is ½ inch thick and made of foam. However, it is contemplated that both the material and thickness of layer 20 may vary depending on the application. For example, protective layer 20 may be formed of other materials such as gypsum, ceramic fiber, phenolic foam, basalt, fiberglass, carbon fiber, phenolic resin, mineral wool or intumescent material.

Testing was performed to demonstrate the efficacy of panel 16. As shown in FIG. 3, panel 16 was exposed to a 1400 degree Fahrenheit heat source 21. Protective layer 18 faced heat source 21, while protective layer 20 was furthest from heat source 21. The ambient starting temperature was 75 F. Heat source 21 was applied directly to panel 16 for 60 minutes. Temperature readings were taken at intervals of 1 minute at the cold face of the test panel.

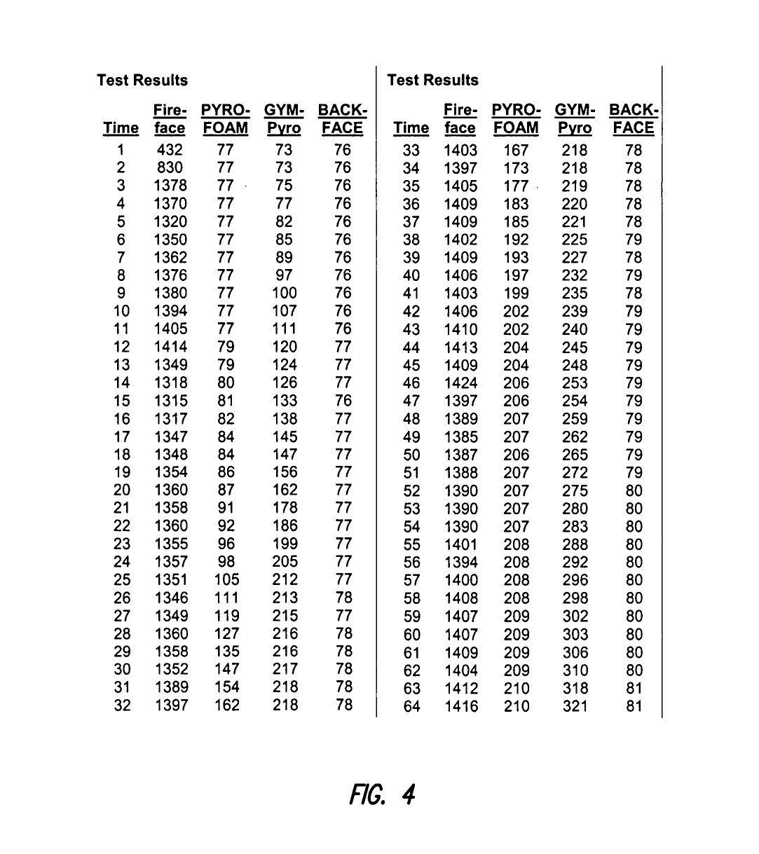

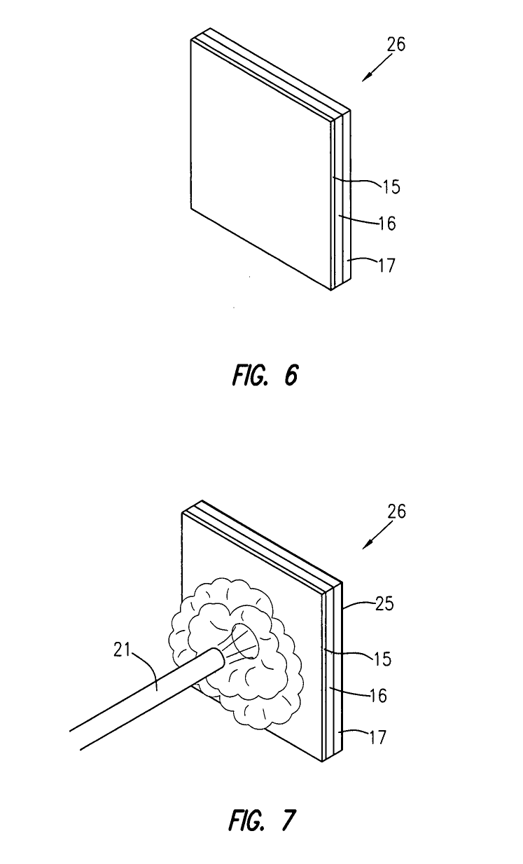

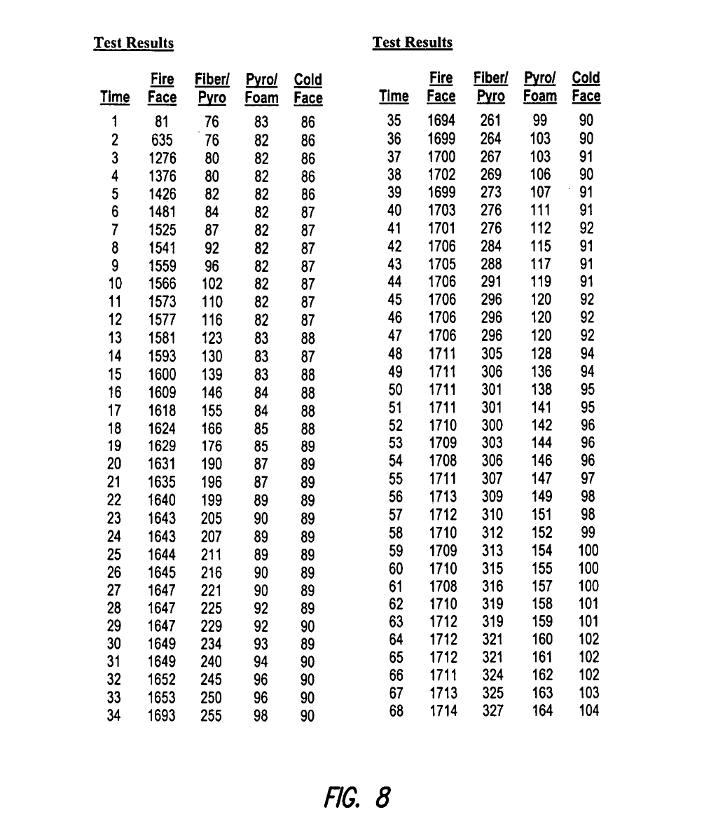

Under these conditions, protective layer 18 reached 1416 F on the hot face. The highest temperature on the cold face of protective layer 20, or the side furthest from heat source 21, only reached 81 F. FIG. 4 is a tabular display of the 60-minute test results for the panel shown in FIG. 2. FIG. 5 displays the results graphically.

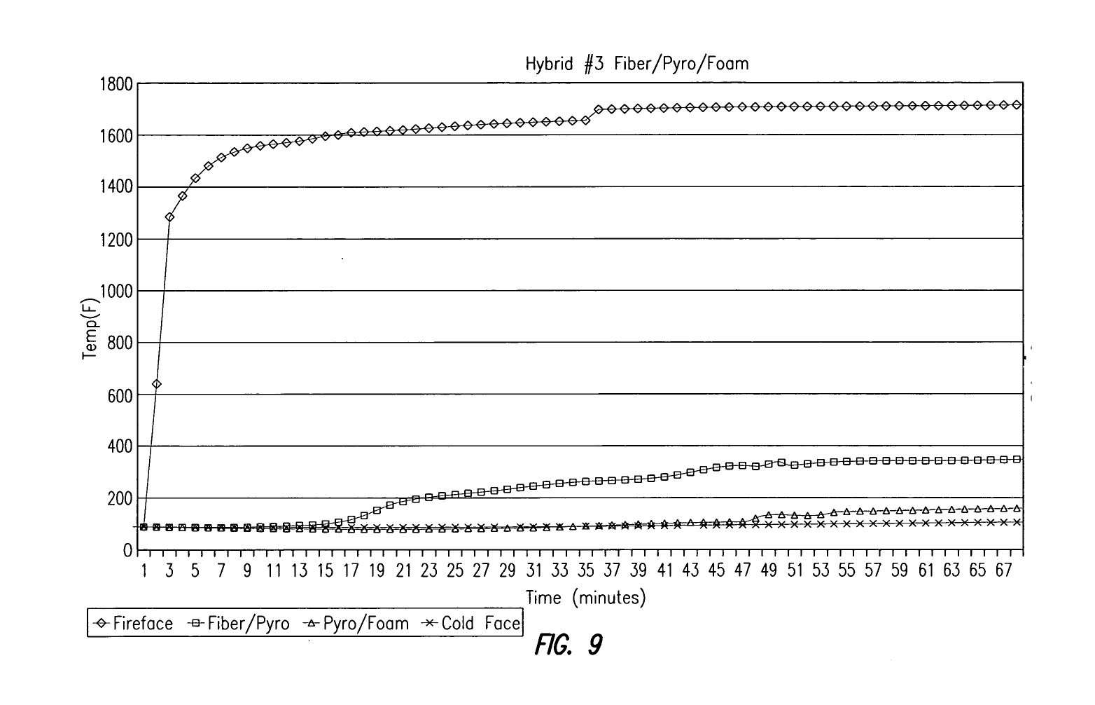

FIG. 6 shows a second embodiment 26. Panel 26 also has three layers 15, 16, and 17. Panel 26 has a total thickness of 62 mm and a weight of 24 pounds per cubic foot. As in the first embodiment, protective layer 15 is adapted to be placed between anticipated heat source 21, and inner resin layer 16. Protective layer 15 is 25 mm thick and made of ceramic board. It is contemplated, however, that both material and thickness of layer 15 may vary depending on the application. For example, protective layer 15 may be formed of other materials such as gypsum, ceramic fiber, phenolic foam, basalt, fiberglass, carbon fiber, phenolic resin, mineral wool or intumescent material.

Resin layer 16 is a phenolic resin composition. Again, resin layer 16 is made with water, phenolic resin, surfactant, boric acid, a lightweight expandable filler, and a catalyst. Resin layer 16 is 25 mm thick, although it is contemplated that thickness may vary depending on the application.

Protective layer 17 is 12 mm thick and made of phenolic foam. Protective layer 17, however, may be formed of other materials such as ceramic fiber, basalt, fiberglass, carbon fiber, phenolic resin, mineral wool or intumescent material.

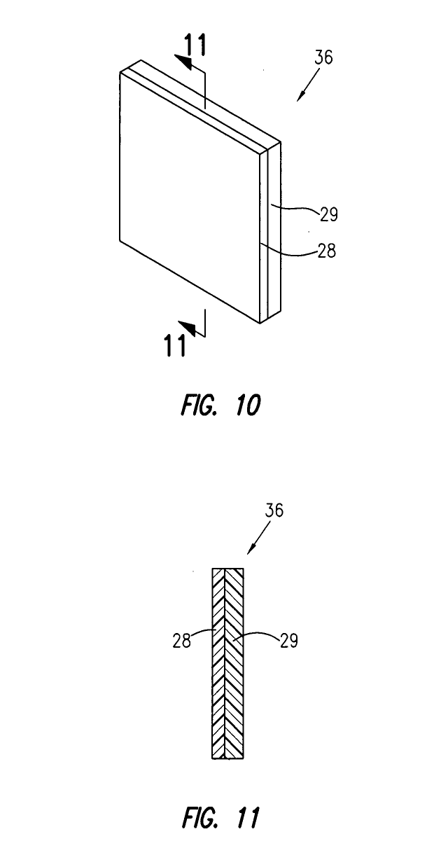

Testing was performed to demonstrate the efficacy of panel 26. To simulate the performance of the fire retardant panel in a fireproof safe or cabinet, the panel was covered with a 1.6 mm stainless steel plate 25, as shown in FIG. 7. Panel 26 was exposed to a 1700 F heat source 21. Protective layer 15 faced heat source 21, while stainless steel plate 25 was furthest from heat source 21. The ambient starting temperature was 75 F. As seen in FIG. 7, the heat source 21 was a torch applied directly to panel 26 shown in FIG. 6. Heat source 21 was applied for 60 minutes. The ambient starting temperature was 84 F. Temperature readings were taken at intervals of 1 minute on the steel plate cold face with thermal couples.

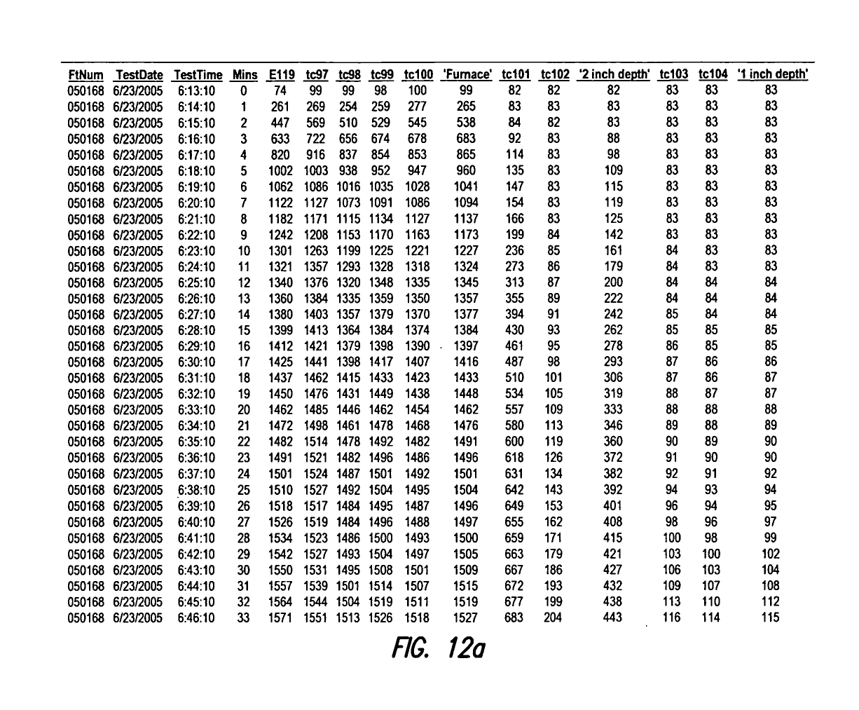

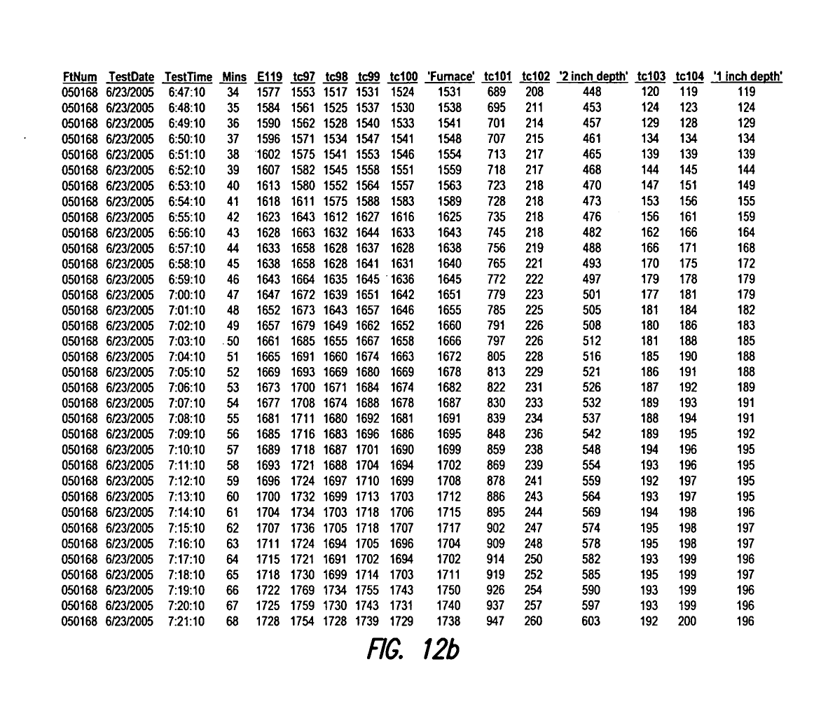

Under these conditions, panel 26 withstood temperatures of up to 1720 F during a 60-minute test and the highest temperature on the cold face of steel plate 25 only reached 104 F. FIG. 8 is a tabular display of the 60-minute test results for panel 26. FIG. 9 displays the results graphically.

Following the 60-minute test, very little of resin layer 16 was consumed during the 60-minute test, and the chemical bonds between layers 15 and 16, and layers 16 and 17 were still intact. It is believed that the addition of both protective layers 15 and 17 increased the thermal barrier and protective value of the panel as it provided a physical layer of protection to the resin core. The use of layer 15 provided insulating value that increased the efficacy of the panel.

Panels 16 and 26 are both formed by the same method. First, resin layer 16/19 is created by mixing wet components and dry components at room temperature until the dry components are completely moistened. Wet components include water, a surfactant and a phenolic resin. In a preferred embodiment, the phenolic resin is a low viscosity unmodified liquid phenolic resole resin. The Cellobond 2027L resin manufactured by Borden Chemical, Inc. of South Glamorgan, UK, may be used. Dry components include boric acid and a lightweight expandable or preexpanded filler. In a preferred embodiment the expandable filler is Expancel (need more detail as there are several different products in the Expancel line). A catalyst is then added to the moistened mixture. In a preferred embodiment, the catalyst is Phencat 10 or Phencat 15, both manufactured by Borden Chemical, Inc. of South Glamorgan, UK.

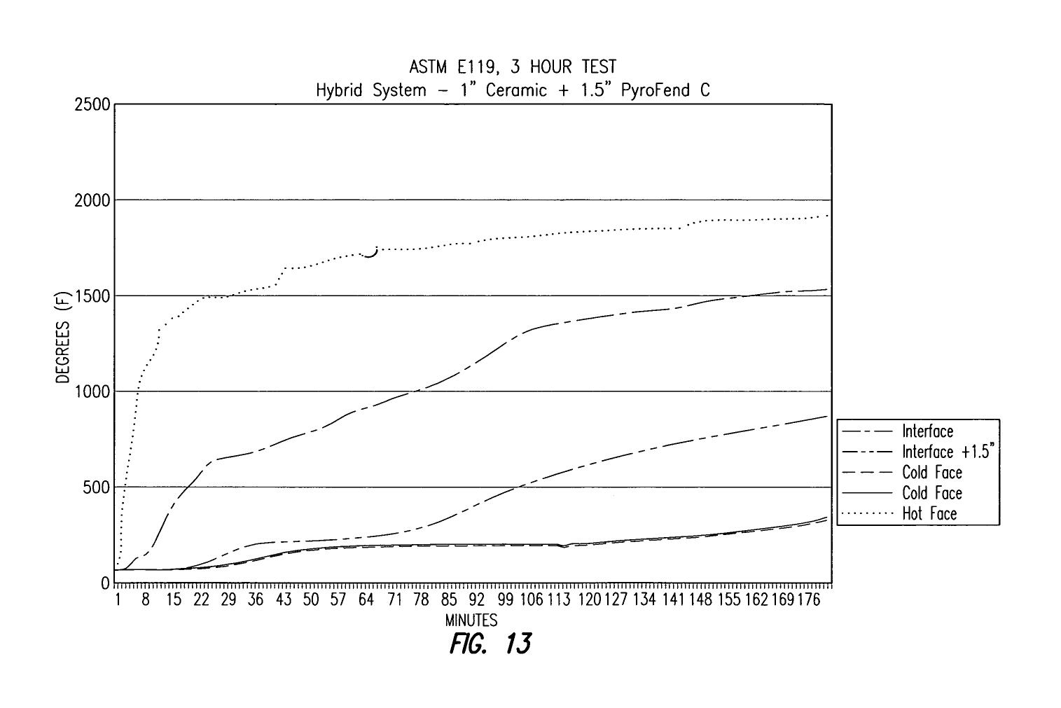

Next, as seen in FIG. 14, mold 23 is provided. Protective layer 15/18 is applied on one side of the interior cavity of mold 23, and protective layer 17/20 is applied on the opposite side of the interior cavity of mold 23. Although this embodiment includes two protective layers 15/18, 17/20, it is contemplated that the mixture may be molded with just one protective layer, or with more than two protective layers as an alternative. Thus, resulting mold 23 is lined with two protective layers, 15/18, 17/20, with a space provided between the two protective layers. The activated resin-based mixture is then poured into mold 23, filling the space between protective layers 15/18 and 17/20. The resin-based mixture must be poured while still in liquid form, before solidification.

Mold 23 is then covered and clamped. The resin-based mixture will chemically expand for 6-8 minutes, and the resultant gas is discharged through vents 24 in mold 23. The expansion time will vary with the temperature of the reagents. Panel 16 or 26 is then allowed to cure at room temperature, although it is contemplated that an oven may be used to accelerate the curing process. Resultant panel 16/26 is a layered composite of two protective layers 15/18, 17/20 and inner resin layer 16/19 sandwiched therebetween. The layers are chemically bonded together so use of an adhesive is not necessary.

Alternatively, for some applications, the phenolic resin-based mixture could be poured into an unlined mold 23 so the resultant hardened resin layer 16/19 is not flanked by protective layers 15/18 and 17/20. This molded resin layer 16/19 can then be coated using a brush or spray with a fire resistant material to create the layered fire retardant barrier panel. The coating may be gypsum, ceramic fiber, phenolic foam, basalt, fiberglass, carbon fiber, mineral wool or intumescent materials. With this method, resin layer 19 will then have a thin outer coating as a protective layer.

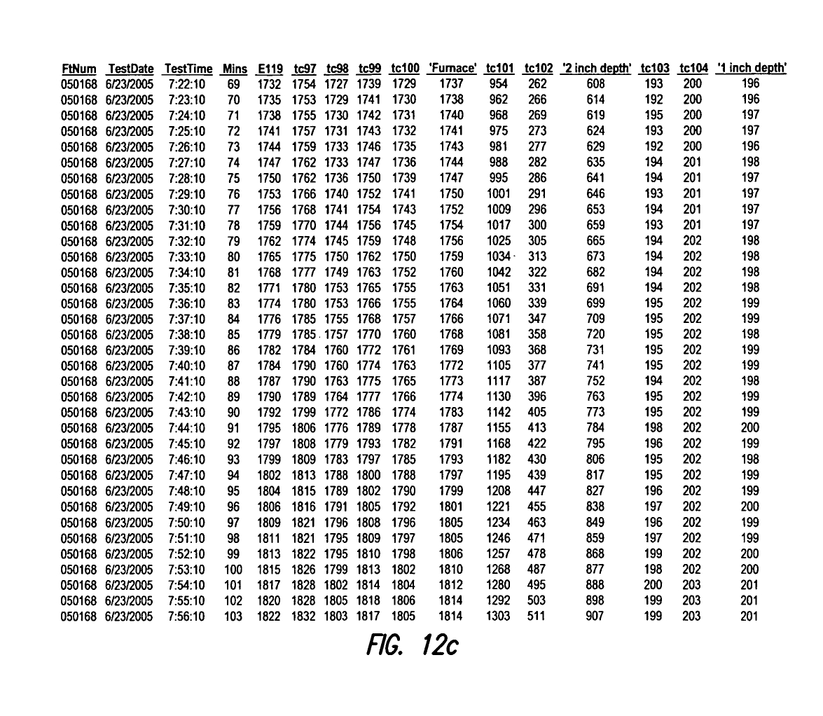

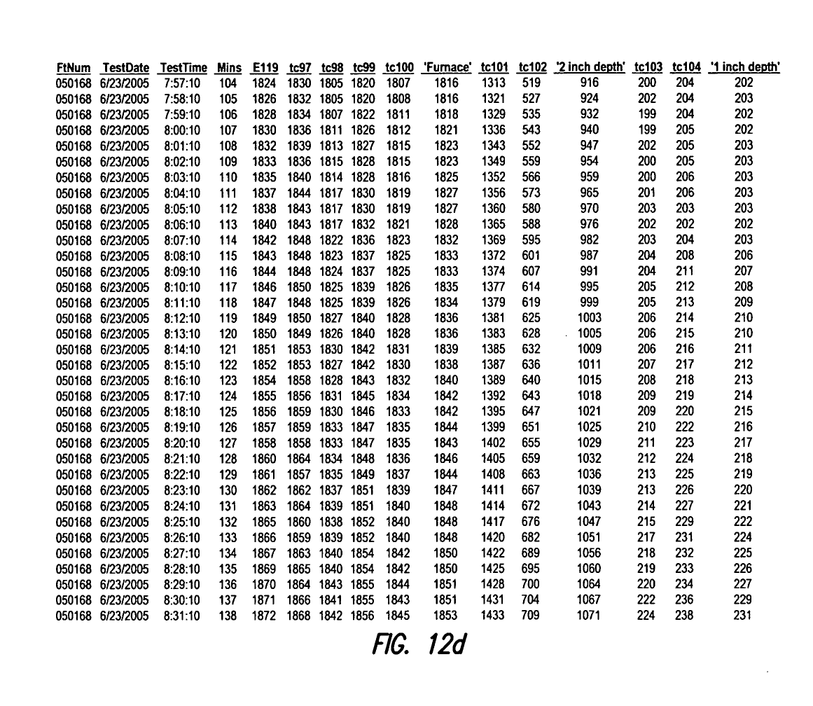

FIGS. 10-13 show a third embodiment 36. Panel 36 is formed from just two laminated layers 28 and 29. Protective layer 28 is adapted to be placed between the anticipated heat source 21, and resin layer 29. In this third embodiment, protective layer 28 is formed of a 1 inch thick ceramic board. It is, however, contemplated that both material and thickness of layer 28 may vary depending on the application. For example, protective layer 28 may be formed of other materials such as gypsum, ceramic fiber, phenolic foam, basalt, fiberglass, carbon fiber, mineral wool or intumescent materials.

Like resin layer 19 in the other embodiments, resin layer 29 is a phenolic resin composition. In this embodiment, resin layer 29 is made with water, phenolic resin, surfactant, boric acid, a lightweight expandable filler, and a catalyst. Resin layer 29 is 1½ inches thick, although the thickness of layer 29 may vary. Since panel 36 does not have a second protective layer like the first two embodiments, the surface of resin layer 29 is adapted to be the cold face. Resin layer 29 therefore serves as the final barrier layer between the heat source 21 and the items panel 36 means to protect.

An ASTM E119 3-hour test was performed to demonstrate the efficacy of panel 36. Panel 36 was exposed to heat source 21. Protective layer 28 faced heat source 21, while resin layer 29 was furthest from the heat source 21. The ambient starting temperature was 83 F. Heat source 21 was applied to protective layer 29 of panel 26 for three (3) hours.

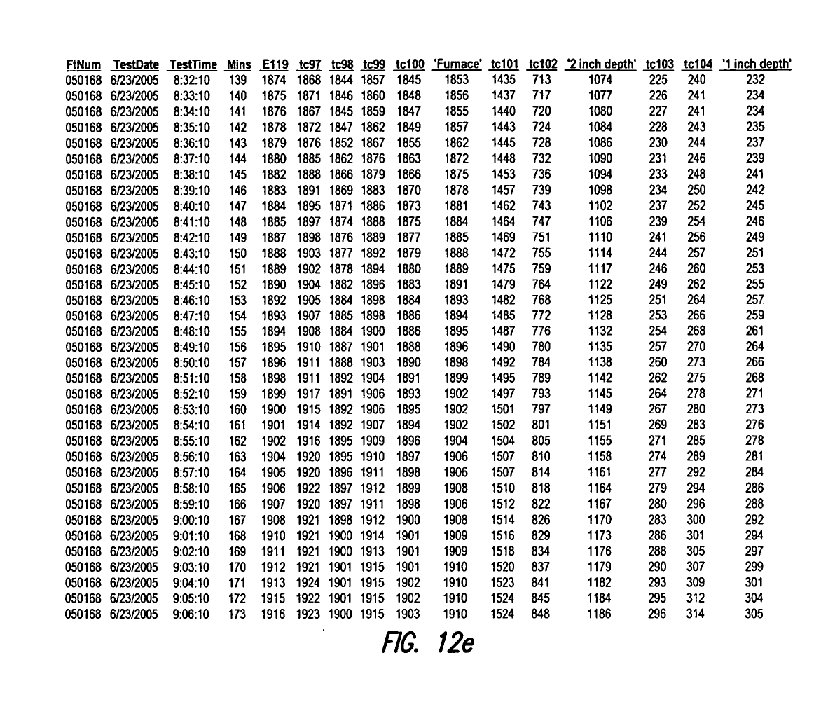

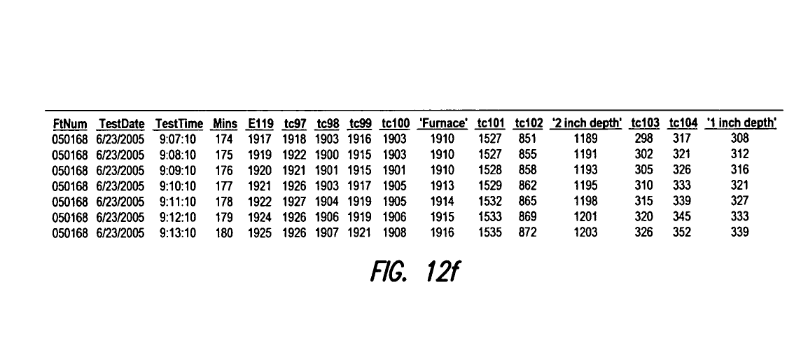

Temperature was measured at intervals of 1 minute in heat source 21, at the interface of protective layer 28 and resin layer 29, ½ inch into resin layer 29 behind the interface of protective layer 28 and resin layer 29, and on two locations on the cold face of resin layer 29. Panel 36 withstood up to 1925 F for 3 hours with no signs of degradation. FIGS. 12a-f are a tabular display of the 3-hour test results for this embodiment. FIG. 13 displays the results graphically. The ceramic of protective layer 28 separated and the heat radiates from inside. This separation demonstrates the importance of an effective chemical bond between the layers of a fire retardant panel. The cold face of resin layer 29 was not heat damaged during testing, with white marks resulting from moisture. The chemical bond between protective layer 28 and resin layer 29 withstood the 3-hour test. Very little of resin layer 29 was consumed during the 3-hour test.

Panel 36 is formed in a series of steps. First, resin layer 29 is created by mixing wet components and dry components at room temperature until the dry components are completely moistened. Wet components include water, a surfactant and a phenolic resin. In a preferred embodiment, the phenolic resin is a low viscosity unmodified liquid phenolic resole resin. The Cellobond 2027L resin manufactured by Borden Chemical, Inc. of South Glamorgan, UK, may be used. Dry components include boric acid and a lightweight expandable filler. In a preferred embodiment the expandable filler is Expancel, Grade 551 WE 40 D 36. A catalyst is then added to the moistened mixture. In a preferred embodiment, the catalyst is Phencat 10 or Phencat 15, both manufactured by Borden Chemical, Inc. of South Glamorgan, UK.

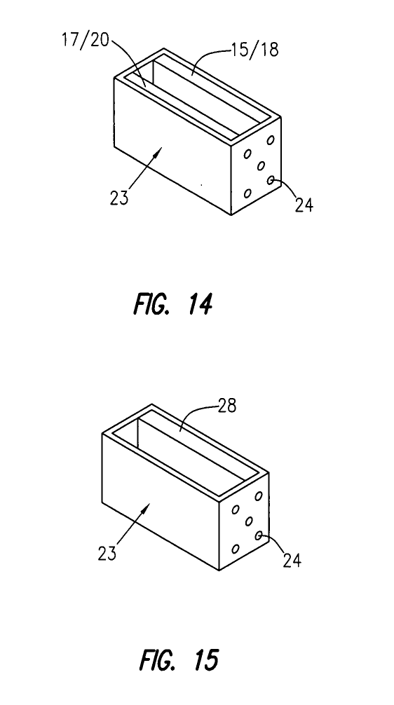

Next, as seen in FIG. 15, mold 23 is provided. Protective layer 28 is applied on one side of the interior cavity of mold 23. Although this embodiment includes one protective layer 28, it is contemplated that the mixture may be molded with more than one protective layer as an alternative. Thus, resulting mold 23 is lined with one protective layer, 28, with a space provided between protective layer 28 and the opposite face of the interior cavity of the mold. The activated resin-based mixture is then poured into mold 23, filling the space between protective layer 28 and the side of mold 23. The resin-based mixture must be poured while still in liquid form, before solidification.

Mold 23 is then covered and clamped. The resin-based mixture will chemically expand for 6-8 minutes, and the resultant gas is discharged through vents 24 in mold 23. The expansion time will vary with the temperature of the reagents. Panel 36 is then allowed to cure at room temperature, although it is contemplated that an oven may be used to accelerate the curing process. Resultant panel 36 is a layered composite of protective layer 28 and resin layer 29 chemically bonded thereto. The layers are chemically bonded together so use of an adhesive is not necessary.

Alternatively, for some applications, the phenolic resin-based mixture could be poured into an unlined mold 23 so the resultant resin layer 29 is not bonded to protective layer 28 during molding. This molded resin layer 29 can then be coated using a brush or spray with a fire resistant material to create the layered fire retardant barrier panel 36. The coating may be gypsum, ceramic fiber, phenolic foam, basalt, fiberglass, carbon fiber, mineral wool, intumescent materials or some other protective layer that is applied. With this method, resin layer 29 will then have a thin outer coating as protective layer 28.

The present invention contemplates that many changes and modifications may be made. Therefore, while the presently-preferred forms of the fire resistant barrier panel have been shown and described, and a number of alternatives discussed, persons skilled in this art will readily appreciate that various additional changes and modifications may be made without departing from the spirit of the invention, as defined and differentiated by the following claims.

What is claimed is:

1. A fire retardant barrier panel comprising:
a first protective layer of a first material;
a fire-resistant phenolic-based resin layer bonded to said first protective layer; and
a second protective layer bonded to said resin layer such that said resin layer is between said first and second protective layers.

2. The panel set forth in claim 1, wherein said first material is selected from a group consisting of gypsum, ceramic fiber, phenolic foam, basalt, fiberglass, carbon fiber, mineral wool and intumescent materials.

3. The panel set forth in claim 1, wherein said resin layer is a phenol or phenolic resin.

4. The panel set forth in claim 1, wherein said second protective layer is selected from a group consisting of gypsum, ceramic fiber, phenolic foam, basalt, fiberglass, carbon fiber, mineral wool and intumescent materials.

5. A method of forming a fire retardant barrier panel comprising the steps of:
providing water, a resin, a surfactant, boric acid, and an expandable filler;
mixing said water, resin, surfactant, boric acid and expandable filler;
adding a catalyst;
providing a mold;
pouring said mixture of water, resin, surfactant, boric acid and expandable filler and said catalyst into said mold; and
allowing said mixture to harden.

6. The method set forth in claim 5, wherein said mold is lined on at least one side with a first protective material.

7. The method set forth in claim 6, wherein said first protective material is selected from a group consisting of gypsum, ceramic fiber, phenolic foam, basalt, fiberglass, carbon fiber, mineral wool and intumescent materials.

8. The method set forth in claim 5, and further comprising the step of coating at least one surface of said hardened material with a first protective layer selected from a group consisting of gypsum, ceramic fiber, phenolic foam, basalt, fiberglass, carbon fiber, mineral wool and intumescent materials.
